(19) United States
(12) Patent Application Publication
(10) Pub. No.: US 2024/0062053 A1
(43) Pub. Date: Feb. 22, 2024

(54) GENERATING AN OUTPUT FOR A RECTIFIED LINEAR UNIT (RELU)-ACTIVATED NEURON OF A NEURAL NETWORK

(71) Applicant: AGENCY FOR SCIENCE, TECHNOLOGY AND RESEARCH, Singapore (SG)

(72) Inventors: Hong Meng Benjamin TAN, Singapore (SG); Souhail MEFTAH, Singapore (SG); Khin Mi Mi AUNG, Singapore (SG)

(21) Appl. No.: 18/260,585

(22) PCT Filed: Jan. 8, 2021
(86) PCT No.: PCT/SG2021/050010

§ 371 Date: Jul. 6, 2023

(51) Int. Cl. G06N 3/063

(52) U.S. Cl. CPC G06N 3/063

(57) ABSTRACT

In some aspects, a set of input elements is obtained, at a rectified linear unit-activated neuron of a neural network based, on input data at the neuron. A first group and a second group of input elements are generated based on the set of input elements. The first group and the second group of input elements are associated with first weight elements and second weight elements, respectively. A first value is generated based on the first group of input elements and the first weight elements. A second value is generated based on the second group of input elements and the second weight elements. A third value and a fourth value are respectively generated based on a first operation and a second operation on the first value and the second value. An output of the neuron is generated based on the third value and the fourth value.

### CROSS-REFERENCE TO RELATED APPLICATION

This application is a 371 National Stage of International Application No. PCT/SG2021/050010, filed on 8 Jan. 2021, the content of which being hereby incorporated by reference in its entirety for all purposes.

### TECHNICAL FIELD

The present disclosure generally relates to generating an output for a rectified linear unit (ReLU)-activated neuron of a neural network.

### BACKGROUND

Neural networks generally are used as computation models with the capacity for machine learning and pattern recognition. A neural network can be defined by a set of input neurons which are activated by input data. After the input data is weighted and transformed by a function, the activations of the neurons are passed to other neurons. The process is repeated until an output neuron is activated to generate an output result that is associated with the input data. Neural network functionality and output results can be based on various types of fields including speech recognition, handwriting recognition, computer vision, and natural language processing. Neural networks can be used in a variety of applications. As an example, neural networks have been shown to be effective in image recognition tasks in healthcare and advanced manufacturing. However, these applications tend to work with privacy-sensitive data which has to be handled appropriately.

Homomorphic encryption is an encryption method with special attributes and can be used to allow data processing without decryption and thus preserve the privacy of the sensitive data. In general, homomorphic encryption is a mapping from a plaintext space to a ciphertext space that preserves arithmetic operations. Compared with other methods of encryption, homomorphic encryption can implement multiple computation functions between ciphertexts in addition to basic encryption operations. Homomorphic encryption allows entities to perform a specific algebraic operation on a ciphertext to obtain a result that is still encrypted. A result obtained by decrypting the ciphertext is the same as a result obtained by performing a same operation on a plaintext. In other words, when homomorphic encryption is used, performing computation before decryption can be equivalent to performing computation after decryption.

Neural networks typically require many layers to achieve useful levels of accuracy, and current state of the art for evaluating deep networks on encrypted data leaves much to be desired. Currently, there are two main approaches to evaluating deep networks on encrypted data. The first approach uses fast arithmetic to evaluate neural networks but approximate an activation function with polynomials (e.g., a Chebyshev approximation or a polynomial regression). This first approach, being an approximation of an activation function, suffers from poor accuracy and cannot scale to deep neural networks. The second approach uses circuit-based methods and has been shown to be able to evaluate deep neural networks with the aid of quantization techniques. However, the second approach has low throughput (either through lack of packing or through not packing enough data), thus leading to long inference times for the neural network. The second approach also faces ciphertext expansion issues; for example, a single bit is encrypted into a ciphertext that is 32 KB large, which can lead to inefficient memory usage.

Therefore, there exists a need for methods of evaluating data using neural networks (e.g., deep neural networks) in a way that preserves the privacy of sensitive data, offers efficient memory usage and short inference times, can scale to deep neural networks where larger datasets are used, and is accurate (e.g., where the neuron's activation function is evaluated exactly and not by mere approximation).

### SUMMARY

According to a first aspect of the present disclosure, a method is provided. The method includes obtaining, at a rectified linear unit-activated neuron of a neural network, a set of input elements based on input data at the neuron. The method further includes generating a first group of input elements based on the set of input elements, where the first group of input elements is associated with first weight elements, each first weight element having a first sign, each input element of the first group of input elements being associated with a respective first weight element. The method also includes generating a second group of input elements based on the set of input elements, where the second group of input elements is associated with second weight elements, each second weight element having a second sign different from the first sign, each input element of the second group of input elements being associated with a respective second weight element. The method additionally includes: generating, by a first accumulator, a first value based on the first group of input elements and the first weight elements; generating, by a second accumulator, a second value based on the second group of input elements and the second weight elements; generating a third value based on a first operation on the first value and the second value; generating a fourth value based on a second operation on the first value and the second value; and generating an output of the neuron based on the third value and the fourth value.

According to a second aspect of the present disclosure, a system is provided. The system includes a memory, and at least one processor communicatively coupled to the memory and configured to perform operations including: obtaining, at a rectified linear unit-activated neuron of a neural network, a set of input elements based on input data at the neuron; generating a first group of input elements based on the set of input elements, where the first group of input elements is associated with first weight elements, each first weight element having a first sign, each input element of the first group of input elements being associated with a respective first weight element; generating a second group of input elements based on the set of input elements, where the second group of input elements is associated with second weight elements, each second weight element having a second sign different from the first sign, each input element of the second group of input elements being associated with a respective second weight element; generating, by a first accumulator, a first value based on the first group of input elements and the first weight elements; generating, by a second accumulator, a second value based on the second group of input elements and the second weight elements; generating a third value based on a first operation on the first value and the second value; generating a fourth value based on a second operation on the first value and the second value; and generating an output of the neuron based on the third value and the fourth value.

According to a third aspect of the present disclosure a non-transitory computer-readable medium is provided. The non-transitory computer-readable medium includes instructions that are operable, when executed by a data processing apparatus, to perform operations including: obtaining, at a rectified linear unit-activated neuron of a neural network, a set of input elements based on input data at the neuron; generating a first group of input elements based on the set of input elements, where the first group of input elements is associated with first weight elements, each first weight element having a first sign, each input element of the first group of input elements being associated with a respective first weight element; generating a second group of input elements based on the set of input elements, where the second group of input elements is associated with second weight elements, each second weight element having a second sign different from the first sign, each input element of the second group of input elements being associated with a respective second weight element; generating, by a first accumulator, a first value based on the first group of input elements and the first weight elements; generating, by a second accumulator, a second value based on the second group of input elements and the second weight elements; generating a third value based on a first operation on the first value and the second value; generating a fourth value based on a second operation on the first value and the second value; and generating an output of the neuron based on the third value and the fourth value.

### BRIEF DESCRIPTION OF THE DRAWINGS

FIG. 1 is a diagram showing an example computing environment, according to an implementation of the present disclosure.

FIG. 2 is a diagram showing an example data owner device, according to an implementation of the present disclosure.

FIG. 3 is a diagram showing an example data operator device, according to an implementation of the present disclosure.

FIG. 4 shows a conceptual diagram illustrating an artificial neural network, according to an implementation of the present disclosure.

FIG. 5 shows an example feed-forward neutral network, according to an implementation of the present disclosure.

FIG. 6 shows another example feed-forward neutral network, according to an implementation of the present disclosure.

FIG. 7 is a graph showing a Rectified Linear Unit (ReLU) function, according to an implementation of the present disclosure.

FIG. 8 shows a flowchart showing an example process performed, for example, to evaluate the output of a ReLU-activated neuron based on its inputs x and weights w, according to an implementation of the present disclosure.

FIG. 9 shows a flowchart showing an example process performed, for example, to generate an output for a ReLU-activated neuron of a neural network, according to an implementation of the present disclosure.

### DETAILED DESCRIPTION

In some aspects of what is described here, an output is generated for a rectified linear unit (ReLU)-activated neuron of a neural network. In some aspects of the present disclosure, a ReLU-activated neuron operates on encrypted data (e.g., homomorphically-encrypted data) without approximation using Q-ary arithmetic and input data that is encoded as a vector of field elements.

In some instances, aspects of the systems and techniques described here provide technical improvements and advantages over existing approaches. For example, aspects of the systems and techniques described here allow more neurons to be computed simultaneously (e.g. through the use of vector field encoding), are not restricted to binary representation (e.g., through the use of Q-ary arithmetic), preserve the privacy of sensitive data, offer efficient memory usage and short inference times, can scale to deep neural networks where larger datasets are used, and are accurate (e.g., where the neuron's activation function is evaluated exactly and not by mere approximation).

FIG. 1 is a diagram showing an example computing environment 100, according to an implementation of the present disclosure. The example computing environment 100 includes a first computing device 102, a second computing device 104, and a communication network 106 that communicatively couples the first and second computing devices 102, 104. The computing environment 100 can be used to implement a confidential computing environment. For example, the first computing device 102 can homomorphically encrypt plaintext data (e.g., a vector of plaintexts) to generate homomorphically encrypted data (e.g., a single ciphertext or multiple ciphertexts). The encrypted data can be sent from the first computing device 102 to the second computing device 104 for processing, without the second computing device 104 having to decrypt the encrypted data from the first computing device 102. Since the encrypted data from the first computing device 102 is not decrypted by the second computing device 104 before, during, or after processing of the encrypted data, the second computing device 104 does not have knowledge of (or access to) the plaintext data of the first computing device 102. Consequently, the computing environment 100 enables computations to be outsourced and executed on encrypted data in a confidential manner, while maintaining security and anonymity of the plaintext data from the first computing device 102.

The first computing device 102 may be a trusted client (or user) device, examples of which include a laptop computer, a smartphone, a personal digital assistant, a tablet computer, a standard personal computer, a mobile device, a smartphone, a smart watch, a smart thermostat, a wireless-enabled camera, or any other type of data processing device. In some implementations, the first computing device 102 includes a plaintext database 108 that includes plaintext data 110. The plaintext data 110 can, in some examples, be a vector of plaintexts. The first computing device 102 is configured to encrypt the plaintext data 110 with a secret key 112 using one or more homomorphic encryption schemes. In some implementations, the homomorphic encryption schemes can be performed by one or more circuits included in the first computing device 102. Example circuits that may perform homomorphic encryption of the plaintext data 110 include one or more Boolean circuits with logic gates (e.g., AND, OR, NAND, or NOT gates, other logic gates or a combination thereof), one or more arithmetic circuits (e.g., with addition, multiplication, or negation functions, other arithmetic functions or a combination thereof), or a combination of Boolean and arithmetic circuits, although other types of circuits may be used to perform the homomorphic encryption. Homomorphic encryption of the plaintext data 110 generates encrypted data 114 (e.g., homomorphically-encrypted data) that may be stored in an encrypted database 116 of the first computing device 102. The encrypted data 114 can, in some examples, be a single ciphertext. The encrypted data 114 may subsequently be sent from the first computing device 102 to the second computing device 104, via the communication network 106, for processing.

The communication network 106 can be the Internet, an intranet, or another wired or wireless communication network. In some implementations, the communication network 106 may be configured to operate according to a wireless network standard or another type of wireless communication protocol. For example, the communication network 106 may be configured to operate as Local Area Network (LAN), a Wide Area Network (WAN), a Wireless Local Area Network (WLAN), a Personal Area Network (PAN), a metropolitan area network (MAN), or another type of wireless network. Examples of WLANs include networks configured to operate according to one or more of the 802.11 family of standards developed by IEEE (e.g., Wi-Fi networks), and others. Examples of PANs include networks that operate according to short-range communication standards (e.g., BLUETOOTH®, Near Field Communication (NFC), ZigBee), millimeter wave communications, and others. In some implementations, the communication network 106 may be configured to operate according to a cellular network standard. Examples of cellular networks standards include: networks configured according to 2G standards such as Global System for Mobile (GSM) and Enhanced Data rates for GSM Evolution (EDGE) or EGPRS; 3G standards such as Code Division Multiple Access (CDMA), Wideband Code Division Multiple Access (WCDMA), Universal Mobile Telecommunications System (UMTS), and Time Division Synchronous Code Division Multiple Access (TD-SCDMA); 4G standards such as Long-Term Evolution (LTE) and LTE-Advanced (LTE-A); 5G standards, and others.

The second computing device 104 may be an untrusted device, for example, a remote server, a cloud-based computer system, or any other type of data processing device that is remote from the first computing device 102. In some examples, the first computing device 102 is operated by a first entity, and the second computing device 104 is operated by a second, different entity (e.g., a third-party cloud service provider). In some implementations, the second computing device 104 includes a data processing apparatus 118 that is configured to execute homomorphic computation processing on the encrypted data 114. The data processing apparatus 118 can include one or more Boolean circuits, one or more arithmetic circuits, or a combination of Boolean and arithmetic circuits, although other types of circuits may be used to implement the data processing apparatus 118.

The result of the homomorphic computation (indicated in FIG. 1 as an encrypted result 120) may subsequently be sent from the second computing device 104 to the first computing device 102 via the communication network 106. The first computing device 102 receives the encrypted result 120 and may store the encrypted result 120 in the encrypted database 116. The first computing device 102 is configured to decrypt the encrypted result 120 with the secret key 112 using one or more homomorphic decryption schemes. In some implementations, the homomorphic decryption schemes can be performed by one or more Boolean circuits, one or more arithmetic circuits, or a combination of Boolean and arithmetic circuits, although other types of circuits may be used to perform the homomorphic decryption. Homomorphic decryption of the encrypted result 120 generates a plaintext result 122 that may be stored in the plaintext database 108 of the first computing device 102.

The computing environment 100 can implement a confidential computing environment for data delegation or privacy-preserving data processing. For example, a data owner (e.g., a user of the first computing device 102) can homomorphically encrypt their plaintext data, and send the homomorphically-encrypted data to a cloud-based server (e.g., the second computing device 104) for processing. The cloud-based server performs homomorphic computation processing on the homomorphically-encrypted data without having to decrypt it and without having to access the secret key or the plaintext data of the data owner, thereby maintaining security and anonymity of plaintext data of the data owner.

One example scenario where the computing environment 100 can be applied is in a medical context. As an illustration, a doctor may obtain medical data associated with a patient. Examples of medical data include electrocardiogram (EKG) information, an x-ray image, a magnetic resonance imaging (MRI) image, a computed tomography (CT) scan, or any other type of medical data. The doctor may analyze the medical data and make a diagnosis as to whether there is any abnormality in the medical data. The abnormality may indicate that there are one or more conditions associated with the patient. In some cases, the diagnosis may be improved by running advanced detection schemes on the medical data, examples being convolutional neural networks machine learning or artificial intelligence systems trained on various medical images for the purpose of diagnosing problems with presented medical data. In such cases, the doctor may outsource the analysis of the medical data to a third-party that executes the advanced detection schemes. However, the medical data may include personal data associated with the patient and may be protected by laws such as HIPAA (Health Insurance Portability and Accountability Act). The doctor can utilize the computing environment 100 to possibly improve the diagnosis, while keeping private the personal data associated with the patient. For example, the doctor may use the first computing device 102 to homomorphically encrypt the medical data and send the homomorphically encrypted medical data to the second computing device 104 for further analysis. Since the second computing device 104 does not decrypt the homomorphically encrypted medical data before, during, or after the analysis, the second computing device 104 does not have access to the personal data associated with the patient.

Another example scenario where the computing environment 100 can be applied is in the credit market. For example, a retail location may have a customer who wishes to open a credit account, and the customer may be asked to complete a credit application that includes credit information and personal data associated with the customer such as a name, an address, or unique identifying information that represents the customer such as a social security number or a national identification number. Although the retail location may be able to analyze the credit application to determine whether to open a customer credit account, it may be possible to perform a more thorough analysis by obtaining access to additional information and decision-making algorithms. The retail location can outsource such analysis to a third-party that executes advanced analysis schemes. The retail location can utilize the computing environment 100 to determine whether to open a customer credit account, while keeping private the personal data associated with the customer. For example, the retail location may use the first computing device 102 to homomorphically encrypt the credit application and send the homomorphically encrypted credit application to the second computing device 104 for further analysis. Since the second computing device 104 does not decrypt the homomorphically encrypted credit application before, during, or after the analysis, the second computing device 104 does not have access to the personal data associated with the customer.

The example scenarios discussed above are merely illustrative and not meant to be limiting, and the computing environment 100 can be applied to other scenarios that involve data delegation or privacy-preserving data processing.

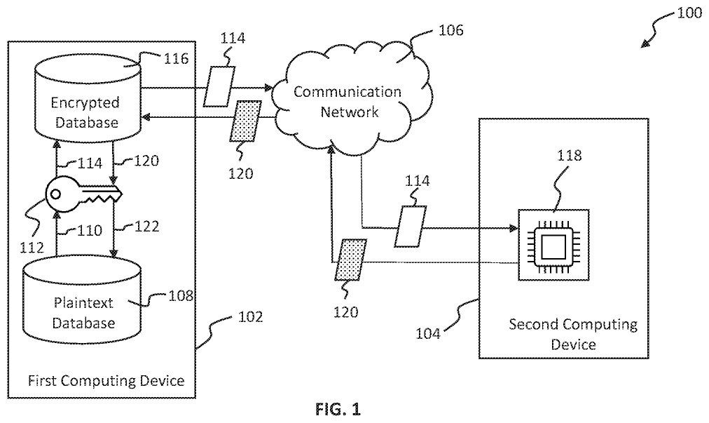

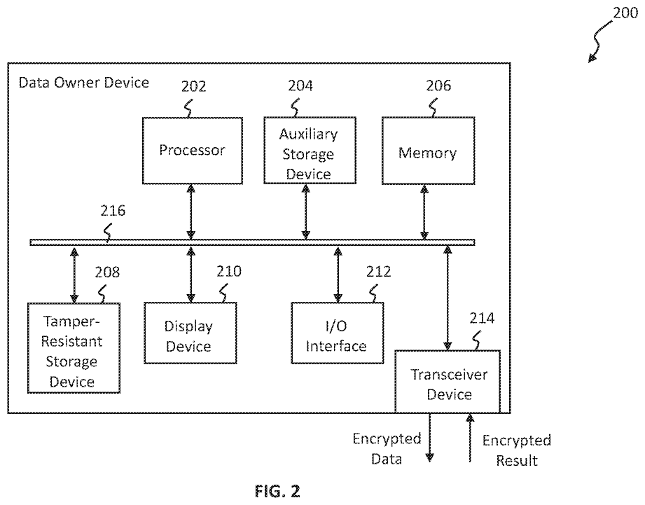

FIG. 2 is a diagram showing an example data owner device 200, according to an implementation of the present disclosure. The data owner device 200 may be an example implementation of the first computing device 102 shown in FIG. 1. In some implementations, the data owner device 200 includes a processor 202 (e.g., a central processing unit), an auxiliary storage device 204 formed by a non-volatile storage device such as Read Only Memory (ROM), and a memory 206 formed by a volatile storage device such as Random Access Memory (RAM). In some implementations, instructions (e.g., for executing homomorphic encryption) are stored in the auxiliary storage device 204. The instructions can include programs, codes, scripts, modules, or other types of data stored in the auxiliary storage device 204. Additionally or alternatively, the instructions can be encoded as pre-programmed or re-programmable logic circuits, logic gates, or other types of hardware or firmware components or modules. The auxiliary storage device 204 may also store plaintext data (e.g., plaintext data 110 in the example of FIG. 1) for encryption. The data owner device 200 also includes a tamper-resistant storage device 208, which may be configured to store a secret key used for encryption and decryption (e.g., the secret key 112 in the example of FIG. 1).

The processor 202 may be or include a general-purpose microprocessor, as a specialized co-processor or another type of data processing apparatus. In some examples, the processor 202 may be formed using one or more Boolean circuits, one or more arithmetic circuits, or a combination of Boolean and arithmetic circuits, although other types of circuits may be used to implement the processor 202. In some cases, the processor 202 performs high level operation of the data owner device 200. For example, the processor 202 may be configured to execute or interpret software, scripts, programs, functions, executables, or other instructions stored in the auxiliary storage device 204. In some instances, the processor 202 may execute the instructions by, for example, reading the instructions onto the memory 206 to perform operations and overall control of the data owner device 200.

The data owner device 200 shown in the example of FIG. 2 further includes a display device 210 (such as a display configured to display processed data), one or more Input/Output (I/O) interfaces 212 to a peripheral device (e.g., a keyboard, a mouse, or any other peripheral device), and a transceiver device 214 (e.g., a modem or any device having a transmitter circuit and a receiver circuit). The transceiver device 214 may be configured to communicate signals formatted according to a wired or wireless communication standard or a cellular network standard such that the data owner device 200 can access the communication network 106 to transmit and receive data. The various components of the data owner device 200 are communicatively coupled to one another via an interconnected bus 216. The various components of the data owner device 200 may be housed together in a common housing or other assembly. In some implementations, one or more of the components of data owner device 200 can be housed separately, for example, in a separate housing or other assembly.

During an example operation of the data owner device 200, the processor 202 accesses the auxiliary storage device 204 and reads the plaintext data and the instructions for executing homomorphic encryption onto the memory 206. The processor 202 may also access the secret key stored in the tamper-resistant storage device 208. The processor 202 may subsequently execute the instructions to homomorphically encrypt the plaintext data (e.g., plaintext data 110 in FIG. 1) using the secret key (e.g., the secret key 112 in FIG. 1), thus generating encrypted data (e.g., the encrypted data 114 in FIG. 1). The encrypted data may be stored in the auxiliary storage device 204 or the memory 206. The transceiver device 214 may transmit the homomorphically encrypted data to a data operator device (e.g., the second computing device 104 in FIG. 1) via the communication network 106.

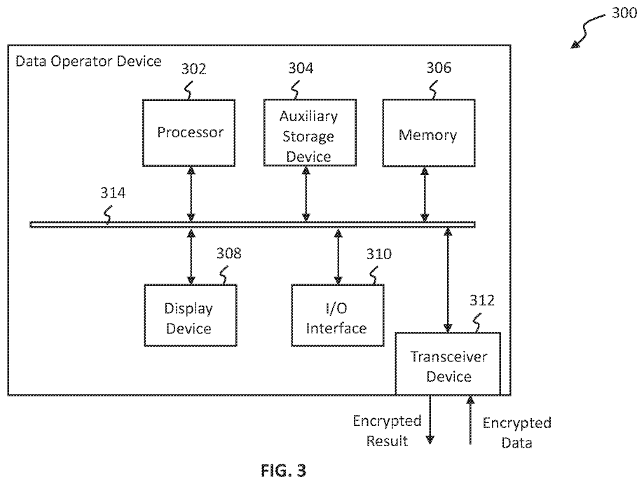

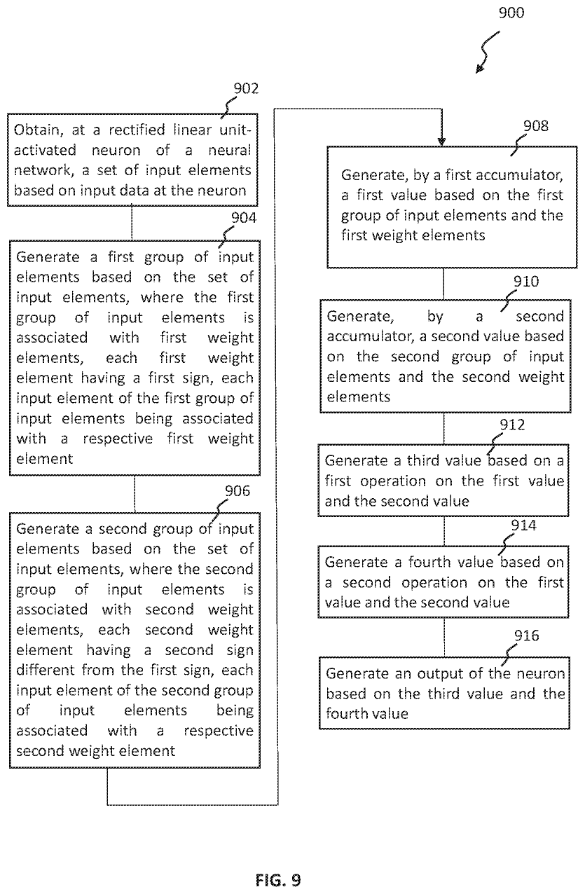

FIG. 3 is a diagram showing an example data operator device 300, according to an implementation of the present disclosure. The data operator device 300 may be an example implementation of the second computing device 104 shown in FIG. 1. In some implementations, the data operator device 300 includes a processor 302 (e.g., a central processing unit), an auxiliary storage device 304 formed by a non-volatile storage device such as ROM, and a memory 306 formed by a volatile storage device such as RAM. In some implementations, instructions (e.g., for executing homomorphic computation processing) are stored in the auxiliary storage device 304. For example, the instructions may include instructions to perform one or more of the operations in the example processes shown in FIGS. 8 and 9. The instructions can include programs, codes, scripts, modules, or other types of data stored in the auxiliary storage device 304. Additionally or alternatively, the instructions can be encoded as pre-programmed or re-programmable logic circuits, logic gates, or other types of hardware or firmware components or modules.

The processor 302 may be or include a general-purpose microprocessor, as a specialized co-processor or another type of data processing apparatus. In some examples, the processor 302 may be formed using one or more Boolean circuits, one or more arithmetic circuits, or a combination of Boolean and arithmetic circuits, although other types of circuits may be used to implement the processor 302. In some instances, the processor 302 can implement one or more of the accumulators used in the example processes shown in FIGS. 8 and 9. In some cases, the processor 302 performs high level operation of the data operator device 300. For example, the processor 302 may be configured to execute or interpret software, scripts, programs, functions, executables, or other instructions stored in the auxiliary storage device 304. In some instances, the processor 302 may execute the instructions by, for example, reading the instructions onto the memory 306 to perform operations and overall control of the data operator device 300.

The data operator device 300 shown in the example of FIG. 3 further includes a display device 308 (such as a display configured to display processed data), one or more I/O interfaces 310 to a peripheral device (e.g., a keyboard, a mouse, or any other peripheral device), and a transceiver device 312 (e.g., a modem or any device having a transmitter circuit and a receiver circuit). The transceiver device 312 may be configured to communicate signals formatted according to a wired or wireless communication standard or a cellular network standard such that the data operator device 300 can access the communication network 106 to transmit and receive data. The various components of the data operator device 300 are communicatively coupled to one another via an interconnected bus 314. The various components of the data operator device 300 may be housed together in a common housing or other assembly. In some implementations, one or more of the components of data operator device 300 can be housed separately, for example, in a separate housing or other assembly.

During an example operation of the data operator device 300, the transceiver device 312 receives the homomorphically encrypted data from the data owner device 200. In some instances, the homomorphically encrypted data received from the data owner device 200 is stored in the memory 306. The processor 302 may access the auxiliary storage device 204 and read the instructions for executing homomorphic computation processing onto the memory 306. The processor 302 may subsequently execute the instructions to perform homomorphic computation processing on the homomorphically encrypted data, thus generating an encrypted result (e.g., the encrypted result 120 in FIG. 1). The encrypted result may be stored in the auxiliary storage device 304 or the memory 306. In some examples, the processor 302 may be formed using one or more Boolean circuits, one or more arithmetic circuits, or a combination of Boolean and arithmetic circuits, although other types of circuits may be used to implement the processor 302. The transceiver device 312 may transmit the encrypted result to the data owner device 200 via the communication network 106. In some examples, the data owner device 200 (e.g., the transceiver device 214 of the data owner device 200) receives the encrypted result from the data operator device 300 and stores the encrypted result in the memory 206. The processor 202 may access the auxiliary storage device 204 and read the instructions for executing homomorphic decryption onto the memory 206. The processor 202 may also access the secret key stored in the tamper-resistant storage device 208. The processor 202 may subsequently execute the instructions to homomorphically decrypt the encrypted result (e.g., encrypted result 120 in FIG. 1) using the secret key (e.g., the secret key 112 in FIG. 1), thus generating a plaintext result (e.g., the plaintext result 122 in FIG. 1). In some implementations, the plaintext result may be stored in the auxiliary storage device 204 or the memory 206.

As discussed above, homomorphic encryption may be performed by the first computing device 102 and the data owner device 200, while homomorphic computation processing may be performed by the second computing device 104 and the data operator device 300. In some instances, an artificial neural network running on the second computing device 104 and the data operator device 300 can perform homomorphic computation processing (e.g., addition, subtraction, multiplication, etc.) on the encrypted data to generate a result that is also encrypted.

FIG. 4 shows a conceptual diagram illustrating an artificial neural network 400, according to an implementation of the present disclosure. The example artificial neural network 400, in which an activation function is executed, includes an input layer, one or more hidden layers, and an output layer. In some instances, the hidden layer(s) may include a numerous number of nodes 402 (also referred to as neurons). The artificial neural network running on the second computing device 104 and the data operator device 300 can, in some instances, be a deep neural network. The illustration in FIG. 4 is an example of a deep neural network; however, aspects of the present disclosure are not necessarily limited to deep neural networks. Feed-forward (marked with a solid line in FIG. 4) and back propagation (marked with a dotted line in FIG. 4) may be used as a method for training a deep neural network. In the feed-forward paths, learning is performed in order of the input layer, the hidden layer(s), and the output layer. An output of a neuron 402 at each hidden layer may be based on a weighted sum of its inputs that is pass through the neuron's activation function. Subsequently, the activation may be differentiated in order of the output layer, the hidden layer, and the input layer so as to perform backward propagation of an error, thereby optimizing a weight. The activation function is directly involved in the feed-forward and backward propagation procedures, thereby greatly influencing learning speed and performance of a deep neural network.

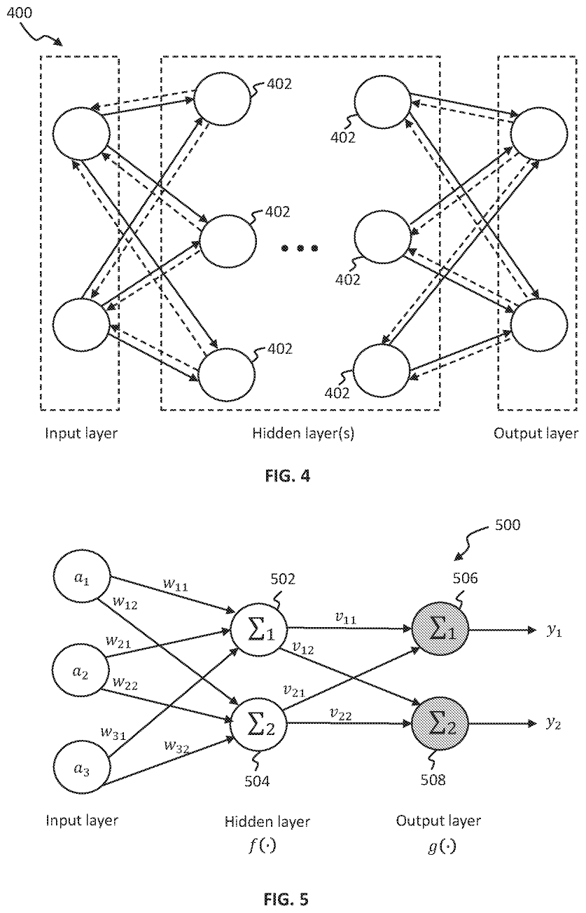

Deep neural networks have evolved with the availability of large training datasets, the power of parallel and distributed computing, and sophisticated training algorithms. Deep neural networks have facilitated major advances in numerous domains such as computer vision, speech recognition, and natural language processing. In some instances, a deep neural network uses multiple nonlinear and complex transforming layers to successively model high-level features. In general, a deep neural network includes multiple layers of feature-detecting neurons. Each layer has one or more neurons that respond to different combinations of inputs from the previous layers. These layers are constructed so that the first layer detects a set of primitive patterns in the raw input data, the second layer detects patterns of the set of primitive patterns from the first layer, and the third layer detects patterns of those patterns from the second layer, and so on. As discussed in relation to FIG. 4, a deep neural network can include a feed-forward neural network (also referred to as multilayer perceptrons) that generates one or more outputs, y, from a set of inputs, x, based on a mapping. For example, a feed-forward network defines a mapping y=f(x;θ) and learns the value of parameters θ that result in the best function approximation. Example feed-forward neutral networks are depicted and discussed in greater detail in FIGS. 4 and 5. As discussed in relation to FIG. 4, a deep neural network can also provide feedback via backpropagation, which carries the difference between observed and predicted output to adjust parameters.

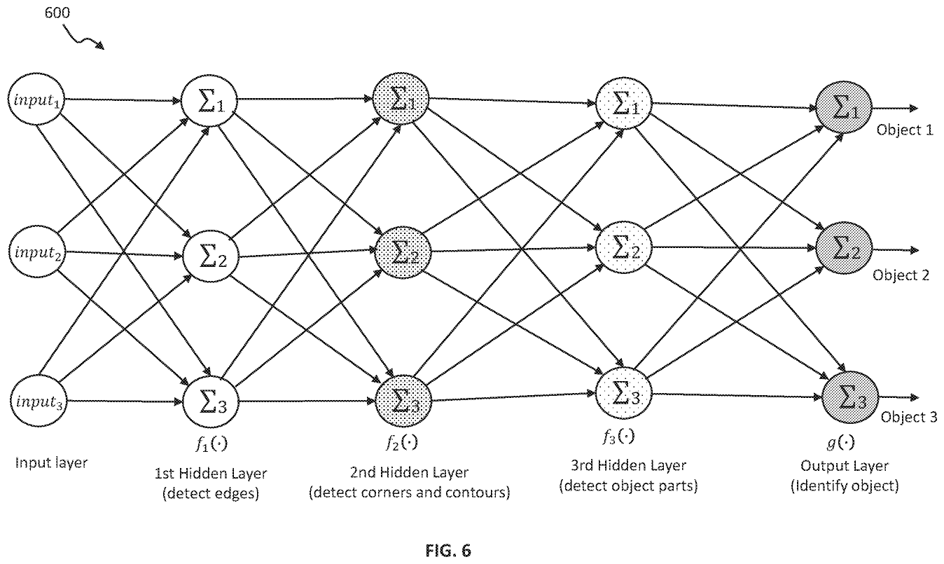

FIG. 5 shows an example feed-forward neutral network 500, according to an implementation of the present disclosure. The example feed-forward neutral network 500 is a system of interconnected artificial neurons that exchange messages between each other. The illustrated feed-forward neutral network 500 has three inputs (e.g., raw input data a₁, a₂, a₃) in a visible (input) layer, two neurons 502, 504 in a hidden layer, and two neurons 506, 508 in an output layer. The number of inputs, layers, and neurons shown in FIG. 5 are merely illustrative, and the number of inputs, hidden layers, and neurons may vary for other implementations of a feed-forward neural network. For example, an example multi-layer feed-forward neural network having multiple hidden layers is shown in FIG. 6. The hidden layer has an activation function f(·), and the output layer has an activation function g(·). The connections have numeric weights (e.g., w₁₁, w₁₂, w₂₁, w₂₂, w₃₁, w₃₂, v₁₁, v₁₂, v₂₁, v₂₂) that are tuned during a neural network training process, so that a properly trained network responds correctly when fed raw input data. The input layer processes the raw input data, and the hidden layer processes the output from the input layer based on the weights of the connections between the input layer and the hidden layer. The output layer takes the output from the hidden layer and processes it based on the weights of the connections between the hidden layer and the output layer. In general, each neuron 502, 504, 506, 508 computes a weighted sum of its inputs and pass the weighted sum through the neuron's activation function. For example, neuron 502 computes the sum (w₁₁a₁+w₂₁a₂+w₃₁a₃) and passes this sum through the activation function f (·) to generate output b₁. As another example, the neuron 506 computes the sum (v₁₁b₁+wv₂₁b₂), where b₁ is the output of neuron 502, and b₂ is the output of neuron 504, and passes this sum through the activation function g(·) to generate output y₁.

FIG. 6 shows an example multi-layer feed-forward neural network 600, according to an implementation of the present disclosure. The example multi-layer feed-forward neural network 600 shown in FIG. 6 operates on an image and accepts raw input data (e.g., raw pixel values) at the input layer. The example multi-layer feed-forward neural network 600 processes the accepts raw input data an generates an identification of the object that is depicted in the image. The example multi-layer feed-forward neural network 600 includes three hidden layers (depicted in FIG. 6 as “1st Hidden Layer,” “2nd Hidden Layer,” and “3rd Hidden Layer”). Different characteristics of an object can be detected at each hidden layer, and the multi-layer feed-forward neural network 600 outputs an identification of the object depicted in the image based on the characteristics detected at each hidden layer. In the example of FIG. 6, raw input data (e.g., input₁, input₂, input₃, examples being raw pixel values) are received at the input layer. The first hidden layer, having an activation function f₁(·), detects edges in the image based on the raw input data and the weights of the connections between the input layer and the first hidden layer. The second hidden layer, having an activation function f₂(·) , detects corners and contours based on the edges detected at the first hidden layer and the weights of the connections between the first hidden layer and the second hidden layer. The third hidden layer, having an activation function f₃(·), detects object parts based on the corners and contours detected at the second hidden layer and the weights of the connections between the second hidden layer and the third hidden layer. The output layer, having an activation function g(·), predicts the object that is depicted in the image based on the object parts detected at the third hidden layer and the weights of the connections between the third hidden layer and the output layer.

In some implementations, convolutional neural networks (CNNs) and recurrent neural networks (RNNs) are components of deep neural networks. Convolutional neural networks can have an architecture that includes convolution layers, nonlinear layers, and pooling layers. Recurrent neural networks are designed to utilize sequential information of input data with cyclic connections among building blocks like perceptrons, long short-term memory units, and gated recurrent units. In addition, many other emergent deep neural networks have been proposed for some contexts, such as deep spatio-temporal neural networks, multi-dimensional recurrent neural networks, and convolutional auto-encoders.

As discussed above, the activation function is directly involved in the feedforward and backward propagation procedures, and each neuron in a deep neural network computes a weighted sum of its inputs and pass the weighted sum through the neuron's activation function. In general, the neuron's activation function is a non-linear function, and the choice of activation functions has a significant effect on the deep neural network's training dynamics and task performance. The activation function may include a Rectified Linear Unit (ReLU) function, a step function, a sigmoid function, a hyperbolic tangent (tan h) function, an absolute of a hyperbolic tangent function, a softplus function (also referred to as smooth rectify), or other types of activation functions. An advantage of using the ReLU function as an activation function is that the deep neural network (e.g., convolutional neural network) can be trained many times faster compared to other types of activation functions. This advantage can be attributed to its computational efficiency, using cheap bit-wise operations instead of exponentiation (e.g., that is used for sigmoids). Furthermore, the ReLU function does not have the vanishing gradient problem and has good convergence in practice. Various aspects of the present disclosure propose techniques for generating an output for a ReLU-activated neuron of a neural network. In some aspects of the present disclosure, a ReLU-activated neuron operates on encrypted data (e.g., homomorphically-encrypted data) without approximation using Q-ary arithmetic and input data that is encoded as a vector of field elements.

For a better understanding of the present disclosure and for ease of reference, the present disclosure is separated into sections, and various concepts that are relevant to the various aspects of the present disclosure are now discussed.

Fully Homomorphic Encryption

In a general aspect, a leveled fully homomorphic encryption (FHE) scheme can support L-depth circuits, where L is a parameter of the FHE scheme. In some examples, a leveled FHE scheme includes at least the following operations:
Key Generation: (pk, evk, sk)←KeyGen(1^{λ}, L), where security parameter A and maximum depth L are provided as inputs to a key generation operation, and where public key pk, evaluation key evk and secret key sk are generated as outputs of the key generation operation.
Encryption: c=m̅←Enc(pk, m), where public key pk and plaintext m∈P for a plaintext space P are provided as inputs to an encryption operation, and where a ciphertext c, which is an encryption of plaintext m, is generated as an output of the encryption operation.
Decryption: m′←Dec(sk, c), where secret key sk and ciphertext c are provided as inputs to a decryption operation, and where a plaintext m′ is generated as an output of the decryption operation.
Evaluation: c′←Eval(evk, φ, m̅₁, m̅₂, . . . , m̅ₙ), where evaluation key evk, an n-variate polynomial φ of total degree≥2^{L}, and n ciphertexts m̅₁, . . . , m̅ₙ are provided as inputs to an evaluation operation, and where a ciphertext c′=φ̅(̅m̅₁̅,̅ m̅₂̅,̅ .̅ .̅ .̅ ,̅ m̅ₙ̅)̅ is generated as an output of the evaluation operation. In some instances, the evaluation operation is an abstraction for the operations that are offered by FHE, which are generally addition and multiplication. In the evaluation operation, addition (XOR) and multiplication (AND) are used on bits to realize the ReLU-activated neurons.

In relation to batching and Frobenius Map operations, some FHE schemes can support SIMD operations, also known as batching, by using Chinese Remainder Theorem on polynomial rings and by selecting a suitable parameter. For example, a cyclotomic polynomial modulus Φₘ(x)= [symbol] ₌₁fᵢ(x) decomposes into [symbol] irreducible factors of degree d modulo p, for a chosen plaintext characteristic p. Then, with the Chinese Remainder Theorem isomorphism

$$\frac{{Z}_{p} [ x ]}{{Φ}_{m} ( x )} ≅ {\prod }_{i = 1}^{ℓ} \frac{{Z}_{p} [ x ]}{{f}_{i} ( x )} ≅ {\prod }_{i = 1}^{ℓ} {𝔽}_{{p}^{d}} ,$$

[symbol]

many [symbol] ₚ_{^{d}} elements can be encrypted in one ciphertext by encoding them into the various

$$\frac{{Z}_{p} [ x ]}{{f}_{i} ( x )} .$$

The expression [symbol] ₚ_{^{d}} denotes a finite field with p^{d} elements. The algebra of each

$$\frac{{Z}_{p} [ x ]}{{f}_{i} ( x )}$$

is [symbol] ₚ_{^{d}} since fᵢ(x) is an irreducible polynomial of degree d modulo p. As a result, the plaintext space of compatible FHE schemes can be partitioned into a vector of plaintext slots, with a single addition or multiplication on ciphertexts resulting in component-wise addition or multiplication on the vector of plaintexts. The plaintext algebra for these slots are finite extension fields [symbol] ₚd, and some conventional homomorphic computation processing schemes perform rotation, shifts, and Frobenius map evaluations without consuming depth for the Brakerski-Gentry-Vaikuntanathan (BGV)-FHE scheme. A ring-large learning with errors (LWE) variant of Brakerski's LWE scheme (known in the field as the Brakerski-Fan-Vercauteren (BFV)-FHE scheme) can also be adapted to support these operations. Furthermore, a software library for homomorphic encryption, known in the field as HElib, implements some operations that fully utilize the plaintext space with BGV as the base FHE scheme.

Q-Ary Adders

Q-ary Half-Adder HA_{Q}: Q-ary extensions to a binary half-adder can be used to design a bootstrapping scheme for a leveled fully homomorphic encryption (FHE) scheme over the integers with non-binary plaintext space. In this connection, Theorem 1, shown below, defines a Q-ary half-adder HA_{Q}.

Theorem 1: For x, y∈ [symbol] _{Q}, the Q-ary half-adder HA_{Q} is defined as (c, s)←HA_{Q}(x, y), such that

c·Q+s=x+y

where c∈{0, 1} and s∈ [symbol] _{Q} are given by

$$s = {[ x + y ]}_{Q} , c = {carry}_{Q} ( x , y ) := {\sum }_{i = 1}^{Q - 1} {( \begin{matrix}x \\ i\end{matrix} )}_{Q} {( \begin{matrix}y \\ Q - i\end{matrix} )}_{Q}$$

where

$${( \begin{matrix}a \\ b\end{matrix} )}_{Q} = a ( a - 1 ) … {( a - b - 1 ) [ b ! ]}_{Q}^{- 1} ,$$

and [b!]_{Q}⁻¹ is the inverse of b! modulo Q. The total multiplicative degree of carry_{Q} is Q, which means that it has depth log Q. The number of Q-ary multiplication gates needed to compute the Q-ary half adder circuit defined above is given by Lemma 1, shown below.

Lemma 1: For Q≥3, the Q-ary half-adder HA_{Q} requires (3Q−6) Q-ary multiplication gates to evaluate. On the other hand, the Q-ary half-adder HA_{Q} uses one AND gate when Q=2 (i.e., the binary half-adder HA₂). These results extend to n−digit Q-ary numbers x, y by performing HA_{Q} on their digits separately and concatenating the respective outputs.

Q-ary Full-Adder FA_{Q}: The Q-ary analog to a binary full adder is the Q-ary Full-Adder FA_{Q}. In the Q-ary Full-Adder FA_{Q}, carry propagation formulas are generalized and an overflow function, shown below, can be used to determine if any carry that reaches some position i would be propagated further.

$${overflow}_{Q} ( {x}_{i} , {y}_{i} ) = {[ 1 - {( {x}_{i} + {y}_{i} + 1 )}^{Q - 1} ]}_{Q} = \{ \begin{matrix}1 , & {if [ {x}_{i} + {y}_{i} ]}_{Q} = Q - 1 ; \\ 0 , & otherwise .\end{matrix}$$

In this connection, Theorem 2, shown below, defines a Q-ary Full-Adder FA_{Q}.

Theorem 2: Let x, y be n−digit Q-ary numbers, i.e., x=Σᵢ₌₀ⁿxᵢQⁱ, y=Σᵢ₌₀ⁿyᵢQᵢ, with xₙ=yₙ=0, and denote the integer sum of (x+y) by z=Σᵢ₌₀ⁿzᵢQⁱ. Then, the n−digit Q-ary full adder is defined as z←FA_{Q,n}(x, y), where

$${z}_{0} = {[ {x}_{0} + {y}_{0} ]}_{Q} , {z}_{1} = {[ {x}_{1} + {y}_{1} + {c}_{0} ]}_{Q}$$

$${z}_{i} = {[ {x}_{i} + {y}_{i} + {c}_{i - 1} + {\sum }_{j = 0}^{i - 2} {t}_{i , j} ]}_{Q} , for 2 \leq i \leq n .$$

Here, cⱼ=carry_{Q}(xⱼ, yⱼ) and t_{i,j}=cⱼΠₖ₌ⱼ₊₁ⁱ⁻¹oₖ, with oₖ=overflow_{Q}(xₖ, yₖ). The n−digit Q-ary full adder FA_{Q,n} may need a depth of (1+log n+log Q) and n²(1+log n) multiplications.

Accumulators

Accumulators are circuits that take as input a set of numbers, {x₁, . . . , xₘ}, and outputs their sum Σᵢ₌₁^{m}xᵢ. A depth-optimized accumulator, CompressAdd_{Q}, which is used in various aspects of the present disclosure, is now introduced.

CompressAdd_{Q}: A depth-optimized accumulator, CompressAdd_{Q}, generalizes a (Q+1:2) compressor, Compress_{Q}, which converts three binary numbers to two binary numbers that share the same sum with constant depth, to Q-ary numbers. To this end, a basic version of Compress_{Q} for 1-digit numbers is first presented (e.g., in Theorem 3). The basic version of Compress_{Q} is then generalized to n−digit numbers by applying Compress_{Q} to the n digits separately and concatenating the respective outputs.

Theorem 3: The Q-ary compressor can be defined as (a, b)←Compress_{Q}(x₀, . . . , x_{Q}) such that:

$${\sum }_{i = 0}^{Q} {x}_{i} = a Q + b ,$$

where a, b∈ [symbol] _{Q} are given by the following:

a=[x₀+x₁+. . . +x_{Q}]_{Q}

b=c₁+c₁+. . . +c_{Q-1}

Here, cᵢ=carry_{Q}(aᵢ, xᵢ) for aᵢ=Σⱼ₌₀ⁱ⁻¹xⱼ. For Q≥3, Compress_{Q} may need a depth of log Q and (3Q²−6Q) multiplications. For Q=2, Compress₂ may need a depth of 1 and 2 multiplications.

From Theorem 3, a depth-optimized accumulator, CompressAdd_{Q}, can be constructed to accumulate intermediate products from textbook multiplication. In some implementations, CompressAdd_{Q} iteratively compresses the number of summands with many parallel calls of Compress_{Q}. For example, let {x₁, . . . , xₘ} be the n−digit Q-ary numbers to be accumulated. Then, the following numbers are obtained with Compress_{Q}:

$$\{ {y}_{1} , … {y}_{⌊ \frac{2 m}{Q + 1} ⌋} + {x}_{m - {[ m ]}_{Q + 1}} , {x}_{m - {[ m ]}_{Q + 1} + 1} , … , {x}_{m} \}$$

In the expression above, the yᵢ's are outputs of the compressors on x₁, . . . , x_{m-[m]}_{_{Q+1}}₋₁ while the remaining xᵢ's are inputs that were not accumulated in the current layer. The process is then repeated on these numbers until two numbers, {a, b}, remain. Following this, the accumulated value, z, is obtained by evaluating the following expression:

z=FA_{Q,n+┌(log}_{_{Q}}_{2)log m┐}(a, b).

The depth complexity of the depth-optimized accumulator, CompressAdd_{Q}, in the general case, is given by Theorem 4.

Theorem 4: Let {x₁, . . . , xₘ} be n−digit Q-ary numbers to be accumulated. Then, Compress_{Q} may need a depth of

$$\frac{log m - log 2}{log ( Q + 1 ) - log 2} \cdot log Q + log n + log Q + 1$$

when Q≥3, and may need a depth a depth of

$$\frac{log m - log 2}{log 3 - log 2} + log n + log 2 when Q = 2 .$$

ReLU-Activated Neuron

As discussed above, an activation function of a neuron may include, or may be, a Rectified Linear Unit (ReLU) function. A ReLU-activated neuron takes two vectors, inputs x=(x₁, . . . , xₘ)∈ [symbol] ⁿ and weights w=(w₁, . . . , wₘ)∈ [symbol] ⁿ, and outputs y such that:

$$y = Re LU ( {\sum }_{i = 1}^{m} {w}_{i} \cdot {x}_{i} ) ,$$

$$where$$

$$Re LU ( z ) = \{ \begin{matrix}z , & if z \geq 0 ; \\ 0 , & otherwise .\end{matrix}$$

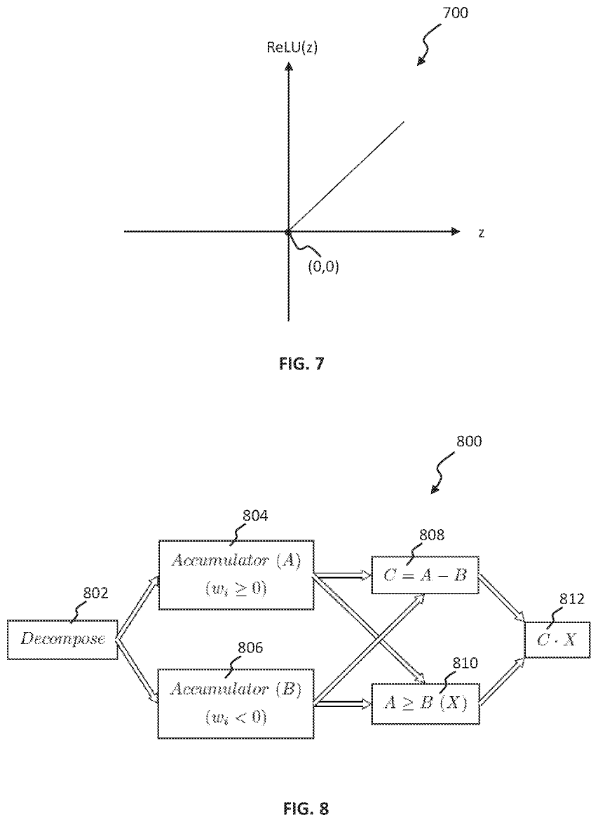

FIG. 7 is a graph showing a Rectified Linear Unit (ReLU) function 700, according to various aspects of the present disclosure. As seen in the example of FIG. 7, the ReLU function 700 is a non-continuous, non-saturating activation function that is linear with respect to the input if the input values are larger than zero, and zero otherwise. As discussed above, the advantage of using the ReLU function 700 as an activation function is that the deep neural network (e.g., convolutional neural network) can be trained many times faster compared to other types activation functions.

Quantization: For better performance, neural networks can be evaluated using neurons that do not require floating point computation. For example, quantization, which restricts the inputs x and weights w to vectors in some finite set, can be used. For example, weights w can be restricted to the set {−2^{-k}, −2^{-(k-1)}, . . . , −2⁻¹, 0, 2⁻¹, . . . , 2^{-k}}. As another example, in evaluating deep convolutional neural networks on encrypted data, inputs x to the neurons can be limited to values that are 5-bits long, meaning that the inputs x to the neurons fall in the set {0, 1, . . . , 31}.

Finite Extension Fields

In various aspects of the present disclosure, a finite extension field [symbol] of characteristic p and extension degree [symbol] is used. In general, [symbol] ={( [symbol] ₌₀⁻¹γᵢtⁱ) mod g(x)|γᵢ∈ [symbol] ₚ, t is a root of an irreducible polynomial g(x)∈ [symbol] ₚ[x]}. Additionally, Lemma 2, described below, can be used to compute linear maps that can be used to extract bits from encoded data.

Lemma 2: Let T be a [symbol] ₚ-linear map on [symbol] for a prime p and a positive integer [symbol] . Denote by τ(x) the Frobenius map on [symbol] that sends x to x^{p}. Then, there is a unique set of constants {ρ₀, ρ₁, . . . , [symbol] }, where ρᵢ∈ [symbol] such that the following holds:

$$T ( μ ) = {ζ}_{T} ( μ ) = {\sum }_{i = 0}^{ℓ - 1} {ρ}_{i} {τ}^{i} ( μ )$$

Digit Extraction

Encoding Data: For plaintext space of [symbol] such that Q is prime and [symbol] ≥8, plaintext inputs can be encrypted as follows:

$$Encode : M = [ 0 , {Q}^{8} ) \to {𝔽}_{{Q}^{ℓ}}$$

$$x = ( {x}_{7} … {x}_{1} {x}_{0} ) ↦ {\sum }_{j = 0}^{7} {x}_{j} {t}^{j} .$$

The Encode operation shown above takes an integer in the range [0, Q⁸), the set of integers representable with 8 Q-ary digits, and encodes it into a finite field element that is then encrypted with FHE. With Q=2, the Encode function encodes the binary representation of 8-bit integers to field elements. Thus, low bit-width integers can be compactly encoded into a single field element to be encrypted into a ciphertexts, instead of encoding the bits separately.

Extraction: For the purposes of the ReLU activation function, the extraction for 8-digit Q-ary integers encoded into field elements can be described. For example, let Extract(x, k) for Σᵢ₌₀⁷xᵢtⁱ∈ [symbol] and k∈{0, . . . , 7} be defined as follows:

Extract(x, k)=xₖ.

Intuitively, Extract(x, k) is a function that extracts the k-th coefficient of x∈ [symbol] , which is equivalent to the k-th Q-ary digit of the integer encoded via Encode.
The function Extract(x, k) can be done in practice by finding the appropriate linear map Tₖ with constants {ρ_{T}_{ₖ}_{,0}, . . . , [symbol] } and applying Lemma 2 with depth-free Frobenius map evaluations. This allows the individual bits or digits of the encoded integers to be homomorphically extracted or recovered, enabling homomorphic evaluations of circuits on the encoded integers using their Q-ary representation.

Evaluating an Output of a ReLU-Activated Neuron

FIG. 8 shows a flowchart showing an example process 800 performed, for example, to evaluate the output of a ReLU-activated neuron based on its inputs x and weights w, according to an implementation of the present disclosure. In some aspects, the process 800 is a circuit-based scheme that exploits a feature of the ReLU function, for example, that its inputs and activations are non-negative. Using this property, non-negative numbers are processed throughout the circuit, and a larger memory space to accommodate negative numbers is obviated.

In some aspects, plaintext data is encoded an then encrypted in a single ciphertext using, for example, the field encoding described above in relation to encoding data. The single ciphertext is provided for homomorphic computation processing using, for example, a deep neural network. In some aspects, at the beginning of neuron computation, individual bits of the encoded inputs are extracted (in 802). For example, the Extract(x, k) operation described above can be used to extract individual bits of the encoded inputs. Operation 802 is optional and can be omitted at the cost of sending multiple ciphertexts that encrypt the individual bits instead. For example, each individual bit of a plaintext message may be encrypted to a separate ciphertext, and the multiple ciphertexts can be provided for homomorphic computation processing using, for example, a deep neural network. In such an example, operation 802 can be omitted.

After recovering the individual bits of the inputs, the inputs and the activations are separated into two accumulators (in 804, 806) based on the sign of their associated weights. In essence, the two accumulator approach partitions inputs by the sign of the weights and accumulates the inputs separately. For example, for a set of weights {wᵢ}ᵢ₌₁^{m} and inputs {xᵢ}ᵢ₌₁^{m}, values A and B are obtained, where A=Σ_{w}_{ᵢ}_{≥0}wᵢxᵢ (in 804) and B=Σ_{w}_{ᵢ}_{<0}(−wᵢ)xᵢ (in 806), and where both A and B are non-negative numbers. In essence, in operations 804 and 806, after recovering the individual bits of the inputs {xᵢ}ᵢ₌₁^{m}, the ciphertexts of bits that are from the same inputs are grouped and multiplied by their associated weights, and the results are assigned to the appropriate accumulators in 804 or 806.

In some aspects, the weights {wᵢ}ᵢ₌₁^{m} can be assumed to be powers of two, and thus multiplications performed to obtain values A and B are simply bit-shifts. The bit shifts can be implemented by re-assigning the ciphertexts to correspond to the more significant bits, and adding encryptions of zeros to the less significant positions. For example, suppose the encrypted 8-bit input x includes the ciphertexts c₇=Enc(x₇), . . . , c₀=Enc(x₀), which is to be multiplied by the weight w=4=2². Then, a right shift by 2 is performed and two encryptions of zeros are appended to the last two positions to compute an encryption of w·x, obtaining c′₉=c₇=Enc(x₇), . . . , c′₂=c₀=Enc(x₀), c′₁=Enc(0), c′₀=Enc(0) . Subsequently, the shifted ciphertexts are assigned to one of the two accumulators A or B (in 804, 806, respectively). The accumulator used to compute value A (in 804) is used to compute the sum of non-negative weighted inputs, and the accumulator used to compute value B (in 806) is used to compute the sum of negative weighted inputs.

In some aspects where a set of batched inputs is present in a single ciphertext (e.g., a group of bits in a ciphertext), slots that are negatively weighted can be zeroed out by multiplying an appropriate plaintext polynomial to all ciphertexts of bits in the group and sending the resulting ciphertexts to an accumulator to compute the value A (in 804). Similarly, slots that are not negatively weighted can be zeroed out by multiplying an appropriate plaintext polynomial to all ciphertexts of bits in the group and sending the resulting ciphertexts to an accumulator to compute the value B (in 806). In some aspects, the accumulators used to compute the values A and B can be implemented using the CampressAdd_{Q} operation discussed above.

In essence, in the operations 804, 806, for each accumulator, corresponding weights are multiplied to the corresponding accumulator. In quantized networks, these multiplications can be implemented using digit shifts (e.g., bit shifts). Furthermore, a (Q+1:2) (e.g., 3:2) compressor, Compress_{Q}, can be used repeatedly to reduce the inputs to two numbers, and a Q-ary (e.g., binary) Full-Adder FA_{Q}(e.g., FA₂) is applied to add the two numbers together.

Following the computation of the values A and B, an operation 808 is performed to compute the value C=(A−B), and an operation 810 is performed to compute the value X, where C and X are given by the following:

$$C = {\sum }_{i = 1}^{m} {w}_{i} {x}_{i} = A - B$$

$$X = GE Q ( A , B ) = \{ \begin{matrix}1 , & if A \geq B ; \\ 0 , & otherwise .\end{matrix}$$

Combining the two results C and X (e.g., in operation 812) generates the activation of ReLU(Σᵢ₌₁^{m}wᵢxᵢ)=C·X. Stated differently, the result of the comparison of the values A and B (the result being the value X) is multiplied with Σᵢ₌₁^{m}wᵢxᵢ, and the result of the multiplication is output as the activation of the ReLU-activated neuron.

In essence, operation 808 is executed by a subtractor. To effect operation 808, in some implementations, the value A is converted to its Q's (e.g. 2's) complement form, A′, and added to the value B with a Q-ary (e.g., binary) Full-Adder FA_{Q}(e.g., FA₂), thus yielding a result C′=A′+B. The result C′ is then converted to its Q's (e.g. 2's) complement form C, which is the value (A−B).

As seen in the process 800, decomposition is omitted for operation 810 since decomposition is performed in operation 802. Furthermore, operation 810 can be equivalent to determining whether the result of the convolution Σᵢ₌₁^{m}wᵢxᵢ is greater than or equal to zero.

In some implementations, the value C=(A−B), which is the subtraction of the two accumulated values A and B is computed as follows. Assuming that all arithmetic falls within [0, Qⁿ), with A=Σ_{w}_{ᵢ}_{≥0}wᵢxᵢ and B=Σ_{w}_{ᵢ}_{<0}(−w ᵢ)xᵢ:

$${\sum }_{i = 1}^{m} {w}_{i} {x}_{i} = ( {Q}^{n} - 1 ) - [ ( {Q}^{n} - 1 - A ) + B ] .$$

The above-provided computation of the value C=(A−B) provides a correct, exact result when A≥B, which is true for a ReLU-activated neuron (e.g., since negative values for a ReLU activation function are zeroed out). Computing (Qⁿ−1−X) for any X=Σⱼ₌₀ⁿ⁻¹XⱼQ^{j}∈[0, Qⁿ) is straightforward and can be obtained by computing (Q−1−Xⱼ) for each 0≤j≤n−1, and computing (Qⁿ−1−A)+B using the full-adder operation FA₂.

Experiments

An experiment was conducted using an Intel Xeon Platinum 8170 platform with maximum turbo frequency of 3.7 GHz and 192 GB RAM. The platform uses 16 threads with parallelization implemented using OpenMP (which is an application programming interface that supports multi-platform shared-memory multiprocessing programming in C, C++, and Fortran, on many platforms, instruction-set architectures and operating systems, including Solaris, AIX, HP-UX, Linux, macOS, and Windows). Parameters used (e.g., HElib parameters are p=2, m=21845, which allows simultaneous evaluation of 1024 neurons on 16-bit inputs. Results of this experiment are presented below in Table 1.

TABLE 1
Neuron Performance for Various Input Sizes

| Input | Sec. | Decomp. | Accumulators | | | | | Total | Amort. |
|---|---|---|---|---|---|---|---|---|---|
| Size | Level | Time | A (Size) | B (Size) | C | X | C · X | Time | Time |
| 25 | 120 | 20.55 | 39.72 (14) | 36.30 (11) | 25.54 | 9.61 | 0.13 | 110.45 | 0.109 |
| 50 | 120 | 41.33 | 50.29 (25) | 49.60 (25) | 23.71 | 9.34 | 0.18 | 135.79 | 0.133 |
| 100 | 105 | 93.34 | 78.00 (53) | 69.21 (47) | 23.87 | 9.55 | 0.18 | 186.65 | 0.182 |
| 200 | 85 | 205.53 | 143.59 (100) | 139.92 (100) | 27.34 | 10.46 | 0.16 | 333.16 | 0.325 |

All timings are given in seconds.

For the experiment, the number of inputs to the neuron were varied and the time taken to complete the computation was measured. The same HElib parameters were used, but the capacity (related to the ciphertext modulus) was adjusted to accommodate the circuit depth of the neuron. This resulted in lower security levels as input sizes increased. As the results in Table 1 show, the bulk of the computing time was spent on the accumulators. This is due to the number of compressors that are required to accumulate the inputs. Breaking down the neuron performance numbers, the first step was to decompose the encrypted integers and extract their individual bits. The first step took around 1 second per input and was the only part of the implementation that was not completely parallelized, with one input being processed at a time. Following that, the individual bits were separated based on the sign of their associated weight values and accumulated in accumulators A and B respectively. The number of inputs going to either accumulator was quite balanced, and so the time spent on either accumulator did not vary significantly. Lastly, the results from accumulators A and B were combined, obtaining C, their difference (A−B) and X, an encrypted bit that contained 1 if X≥Y, and 0 otherwise. The time taken to compute these two operations do not differ significantly in all the experiments as the bit-length of the outputs of A and B do not change significantly between the tested input sizes (within one or two of each other). Altogether, considering that each evaluation worked on 1024 inputs, each neuron only required up to around 330 ms to compute.

FIG. 9 shows a flowchart showing an example process 900 performed, for example, to generate an output for a rectified linear unit (ReLU)-activated neuron of a neural network, according to an implementation of the present disclosure. The process 900 includes obtaining, at a rectified linear unit-activated neuron of a neural network, a set of input elements (e.g., inputs x=(x₁, . . . , xₘ)∈ [symbol] ⁿ or inputs {xᵢ}ᵢ₌₁^{m} discussed above) based on input data at the neuron (at 902).

The process 900 includes generating a first group of input elements based on the set of input elements (at 904). The first group of input elements (e.g., some of the inputs {xᵢ}ᵢ₌₁^{m} is associated with first weight elements (e.g., some of the weights {wᵢ}ᵢ₌₁^{m}, where each first weight element has a first sign (e.g., wᵢ≥0), and where each input element of the first group of input elements is associated with a respective first weight element.

The process 900 includes generating a second group of input elements based on the set of input elements (at 906). The second group of input elements (e.g., others of the inputs {xᵢ}ᵢ₌₁^{m} is associated with second weight elements (e.g., others of the weights {wᵢ}ᵢ₌₁^{m}, where each second weight element having a second sign (e.g., wᵢ<0) different from the first sign, and where each input element of the second group of input elements being associated with a respective second weight element.

The process 900 includes generating, by a first accumulator, a first value (e.g., the value A discussed above) based on the first group of input elements and the first weight elements (e.g., where A=Σ_{w}_{ᵢ}_{≥0}wᵢxᵢ) (at 908). The process 900 includes generating, by a second accumulator, a second value (e.g., the value B discussed above) based on the second group of input elements and the second weight elements (e.g., where B=Σ_{w}_{ᵢ}_{<<0}(−wᵢ)xᵢ) (at 910 ). The process 900 includes generating a third value (e.g., the value C discussed above) based on a first operation on the first value and the second value (at 912). The process 900 includes generating a fourth value (e.g., the value X=GEQ(A, B) discussed above) based on a second operation on the first value and the second value (at 914). The process 900 includes generating an output (e.g., the value ReLU(Σᵢ₌₁^{m}Wᵢxᵢ=C·X discussed above) of the neuron based on the third value and the fourth value (at 916).

Some of the subject matter and operations described in this specification can be implemented in digital electronic circuitry, or in computer software, firmware, or hardware, including the structures disclosed in this specification and their structural equivalents, or in combinations of one or more of them. Some of the subject matter described in this specification can be implemented as one or more computer programs, i.e., one or more modules of computer program instructions, encoded on a computer storage medium for execution by, or to control the operation of, data-processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

Some of the operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

To provide for interaction with a user, operations can be implemented on a computer having a display device (e.g., a monitor, or another type of display device) for displaying information to the user and a keyboard and a pointing device (e.g., a mouse, a trackball, a tablet, a touch sensitive screen, or another type of pointing device) by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

In a general aspect, an output is generated for a rectified linear unit (ReLU)-activated neuron of a neural network.

In a first example, a method includes obtaining, at a rectified linear unit-activated neuron of a neural network, a set of input elements based on input data at the neuron. The method further includes generating a first group of input elements based on the set of input elements, where the first group of input elements is associated with first weight elements, each first weight element having a first sign, each input element of the first group of input elements being associated with a respective first weight element. The method also includes generating a second group of input elements based on the set of input elements, where the second group of input elements is associated with second weight elements, each second weight element having a second sign different from the first sign, each input element of the second group of input elements being associated with a respective second weight element. The method additionally includes: generating, by a first accumulator, a first value based on the first group of input elements and the first weight elements; generating, by a second accumulator, a second value based on the second group of input elements and the second weight elements; generating a third value based on a first operation on the first value and the second value; generating a fourth value based on a second operation on the first value and the second value; and generating an output of the neuron based on the third value and the fourth value.

Implementations of the first example may include one or more of the following features. The input data may include, or may be, homomorphically-encrypted input data. The input data may be an element of a finite extension field, and obtaining the set of input elements based on the input data may include decomposing the input data into the set of input elements based on a set of linear maps on the finite extension field. Generating, by the first accumulator, the first value based on the first group of input elements and the first weight elements may include generating a weighted sum of the first group of input elements, each input element of the first group of input elements being weighted by its respective first weight element. Each of the first weight elements may be non-negative. Generating, by the second accumulator, the second value based on the second group of input elements and the second weight elements may include a weighted sum of the second group of input elements, each input element of the second group of input elements being weighted by a negation of its respective second weight element. Each of the second weight elements may be negative. Generating the third value based on the first operation on the first value and the second value may include subtracting the second value from the first value to obtain the third value. Generating the fourth value based on the second operation on the first value and the second value may include equating the fourth value to one in response to the first value being greater than or equal to the second value, and equating the fourth value to zero in response to the first value being less than the second value. Generating the output of the neuron based on the third value and the fourth value may include obtaining a product of the third value and the fourth value, and providing the product of the third value and the fourth value as the output of the neuron.

In a second example, a system includes a memory, and at least one processor communicatively coupled to the memory and configured to perform operations of the first example. In a third example, a non-transitory computer-readable medium stores instructions that are operable when executed by a data processing apparatus to perform one or more operations of the first example.

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple embodiments separately or in any suitable subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made. Accordingly, other embodiments are within the scope of the following claims.

1. A method, comprising:
obtaining, at a rectified linear unit-activated neuron of a neural network, a set of input elements based on input data at the neuron;
generating a first group of input elements based on the set of input elements, wherein the first group of input elements is associated with first weight elements, each first weight element having a first sign, each input element of the first group of input elements being associated with a respective first weight element;
generating a second group of input elements based on the set of input elements, wherein the second group of input elements is associated with second weight elements, each second weight element having a second sign different from the first sign, each input element of the second group of input elements being associated with a respective second weight element;
generating, by a first accumulator, a first value based on the first group of input elements and the first weight elements;
generating, by a second accumulator, a second value based on the second group of input elements and the second weight elements;
generating a third value based on a first operation on the first value and the second value;
generating a fourth value based on a second operation on the first value and the second value; and
generating an output of the neuron based on the third value and the fourth value.

2. The method of claim 1, wherein the input data comprises homomorphically-encrypted input data.

3. The method of claim 1, wherein the input data is an element of a finite extension field, and obtaining the set of input elements based on the input data comprises decomposing the input data into the set of input elements based on a set of linear maps on the finite extension field.

4. The method of claim 1, wherein generating, by the first accumulator, the first value based on the first group of input elements and the first weight elements comprises generating a weighted sum of the first group of input elements, each input element of the first group of input elements being weighted by its respective first weight element.

5. The method of claim 4, wherein each of the first weight elements is non-negative.

6. The method of claim 1, wherein generating, by the second accumulator, the second value based on the second group of input elements and the second weight elements comprises a weighted sum of the second group of input elements, each input element of the second group of input elements being weighted by a negation of its respective second weight element.

7. The method of claim 6, wherein each of the second weight elements is negative.

8. The method of claim 1, wherein generating the third value based on the first operation on the first value and the second value comprises subtracting the second value from the first value to obtain the third value.

9. The method of claim 1, wherein generating the fourth value based on the second operation on the first value and the second value comprises:
equating the fourth value to one in response to the first value being greater than or equal to the second value; and
equating the fourth value to zero in response to the first value being less than the second value.

10. The method of claim 1, wherein generating the output of the neuron based on the third value and the fourth value comprises:
obtaining a product of the third value and the fourth value; and
providing the product of the third value and the fourth value as the output of the neuron.

11. A system, comprising:
a memory; and
at least one processor communicatively coupled to the memory and configured to perform operations comprising:
obtaining, at a rectified linear unit-activated neuron of a neural network, a set of input elements based on input data at the neuron;
generating a first group of input elements based on the set of input elements, wherein the first group of input elements is associated with first weight elements, each first weight element having a first sign, each input element of the first group of input elements being associated with a respective first weight element;
generating a second group of input elements based on the set of input elements, wherein the second group of input elements is associated with second weight elements, each second weight element having a second sign different from the first sign, each input element of the second group of input elements being associated with a respective second weight element;
generating, by a first accumulator, a first value based on the first group of input elements and the first weight elements;
generating, by a second accumulator, a second value based on the second group of input elements and the second weight elements;
generating a third value based on a first operation on the first value and the second value;
generating a fourth value based on a second operation on the first value and the second value; and
generating an output of the neuron based on the third value and the fourth value.

12. The system of claim 11, wherein the input data comprises homomorphically-encrypted input data.

13. The system of claim 11, wherein generating, by the first accumulator, the first value based on the first group of input elements and the first weight elements comprises generating a weighted sum of the first group of input elements, each input element of the first group of input elements being weighted by its respective first weight element.

14. The system of claim 13, wherein each of the first weight elements is non-negative.

15. The system of claim 11, wherein generating, by the second accumulator, the second value based on the second group of input elements and the second weight elements comprises a weighted sum of the second group of input elements, each input element of the second group of input elements being weighted by a negation of its respective second weight element.

16. The system of claim 15, wherein each of the second weight elements is negative.

17. The system of claim 11, wherein generating the third value based on the first operation on the first value and the second value comprises subtracting the second value from the first value to obtain the third value.

18. The system of claim 11, wherein generating the fourth value based on the second operation on the first value and the second value comprises:
equating the fourth value to one in response to the first value being greater than or equal to the second value; and
equating the fourth value to zero in response to the first value being less than the second value.

19. The system of claim 11, wherein generating the output of the neuron based on the third value and the fourth value comprises:
obtaining a product of the third value and the fourth value; and
providing the product of the third value and the fourth value as the output of the neuron.

20. A non-transitory computer-readable medium comprising instructions that are operable, when executed by a data processing apparatus, to perform operations comprising:
obtaining, at a rectified linear unit-activated neuron of a neural network, a set of input elements based on input data at the neuron;
generating a first group of input elements based on the set of input elements, wherein the first group of input elements is associated with first weight elements, each first weight element having a first sign, each input element of the first group of input elements being associated with a respective first weight element;
generating a second group of input elements based on the set of input elements, wherein the second group of input elements is associated with second weight elements, each second weight element having a second sign different from the first sign, each input element of the second group of input elements being associated with a respective second weight element;
generating, by a first accumulator, a first value based on the first group of input elements and the first weight elements;
generating, by a second accumulator, a second value based on the second group of input elements and the second weight elements;
generating a third value based on a first operation on the first value and the second value;
generating a fourth value based on a second operation on the first value and the second value; and
generating an output of the neuron based on the third value and the fourth value.
